(19) United States
(12) Patent Application Publication
(10) Pub. No.: US 2008/0267016 A1
(43) Pub. Date: Oct. 30, 2008

(54) Electric Counter Circuit

(75) Inventors: Robert Spindler, Graz (AT); Roland Brandl, Eggersdorf bei Graz (AT); Ewald Bergler, Weiz (AT)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/097,039

(22) PCT Filed: Dec. 6, 2006
(86) PCT No.: PCT/IB06/54627

§ 371 Date: Jun. 11, 2008

(30) Foreign Application Priority Data
Dec. 12, 2005 (EP) 05111956.8
Dec. 6, 2006 (IB) PCT/IB2006/054627

(51) Int. Cl. G04F 10/04

(52) U.S. Cl. 368/118

(57) ABSTRACT

An electric counter circuit (30, 40, 80) comprises a clock generator (1, 54, 111, 120, 130) for generating a plurality of clock signals (21-24, 121-125, 131-134) and a sampling device (32, 81) for sampling the clock signals (21-24, 121-125, 131-134) at a first moment in time when a first characteristic signal section (LE) of a digital signal (DS) appears. Furthermore, the circuit (30, 40, 80) comprises a calculation device (33) for calculating the time between the first moment and a second moment which is later than the first moment. This calculation is based on the clock signals (21-24, 121-125, 131-134) at the first moment and based on the clock signals (21-24, 121-125, 131-134) at the second moment. The clock signals (21-24, 121-125, 131-134) each have the same cycle duration (T) and are phase-shifted with respect to each other.

### FIELD OF THE INVENTION

The invention relates to an electric counter circuit and to an electric circuit.

### BACKGROUND OF THE INVENTION

Electric counter circuits, which are often used to measure time, are clocked by a clock signal. The time resolution of the counter circuit depends on the cycle duration of the clock signal, i.e. on the associated fundamental frequency of the clock signal. Nevertheless, it is not only the count resolution that increases with an increasing clock frequency, but also the power consumption of the clock signal generator.

U.S. Pat. No. 6,388,492 B2 discloses a clock generation circuit including a multiphase clock generation circuit for generating multiphase clocks of a predetermined frequency, pulse generation circuits for generating a plurality of non-overlap pulses by using at least a part of the multiphase clocks, and a circuit for obtaining an OR of the plurality of non-overlap pulses, thereby generating a clock not having a simple whole multiple ratio relationship with respect to a frequency of the multiphase clocks or a clock having a higher frequency without causing an increase of power consumption and an increase of chip area. Thus, a clock having a frequency which is different from that of the multiphase clocks is generated.

### OBJECT AND SUMMARY OF THE INVENTION

It is an object of the invention to provide an electric counter circuit which affords the time resolution associated with a relatively high clock frequency without putting up with the relatively high power consumption associated with the relatively high clock frequency.

According to the invention, the above object is achieved by an electric counter circuit comprising: a clock generator for generating a plurality of clock signals, each having the same cycle duration and being phase-shifted with respect to each other, a sampling device for sampling the clock signals at a first moment in time when a first characteristic signal section of a digital signal appears; and a calculation device for calculating the time which has elapsed between the first moment and a second moment in time which is later than said first moment, based on the clock signals at the first moment and based on the clock signals at the second moment in time. The second moment may be the current moment in time so that the counter circuit according to the invention measures the time which has elapsed since the first signal section appeared in an ongoing way. The first characteristic signal section may be particularly a rising or a falling edge of the digital signal. The characteristic signal section may also be a minimum or a maximum of the digital signal. The counter circuit according to the invention starts counting when the characteristic signal section of the digital signal appears. Then, the sampling device, for instance, a sample-and-hold device or a latch circuit, samples the actual clock signals at that moment in time, i.e. at the first moment. In order to obtain all the states of the clock signals, it is sometimes possible to sample only some of the clock signals. This is especially the case if each clock signal lags its preceding clock signal by the same time period. For example, if four clock signals are used and each clock signal lags its preceding clock signal by a quarter of their cycle durations, i.e. by 90°, the four clock signals define four different states. However, the four different states can also be determined if the states of two consecutive clock signals are evaluated. If the counter device according to the invention is supposed to determine the time which has elapsed since the appearance of the first characteristic signal section, the second moment in time is the present moment. Then, the relationship between the current states of the clock signals and the states of the clock signals at the first moment of the characteristic signal section have to be evaluated.

If the calculating device determines the time between the two moments only on the clock signals at these two moments, the maximum count will correspond to a time which is less than the cycle duration of the clock signals. In a limited version of the counter circuit according to the invention, the counter circuit therefore comprises a counter device which is clocked by one of the clock signals and generates a count based on this clock signal. The calculation device is further configured to determine the time between the two moments based on the corresponding clock signals and based on the count of the counter device.

The clock generator generates the plurality of clock signals. Particularly, the clock generator may comprise an oscillator for generating a base clock signal, and a signal-processing device for generating the plurality of clock signals from the base clock signal. The clock generator may also be a ring oscillator.

The counter circuit according to the invention may be used to measure the time between two characteristic signal sections of the digital signal. Then, the second characteristic signal section lags the first characteristic signal section and the circuit according to the invention comprises a device for sampling the clock signals when the second characteristic signal section of the digital signal appears, i.e. at the second moment. The second characteristic signal section may be particularly a rising or a falling edge of the digital signal or a maximum or a minimum of the digital signal.

The counter circuit according to the invention may be particularly part of an electric circuit which comprises an additional sampling circuit for sampling the digital signal. Such an electric circuit is, for instance, a transponder, which may be used in an RFID tag or in a smart card. When such a transponder receives the digital signal, it has to estimate the data rate of an associated reader. For this reason, the digital signal may have a prefix signal section and a main data section. The prefix section may have the first characteristic signal section leading the second signal characteristic section. The time between the two characteristic sections comprises information about the data rate of the transponder. Then, the electric circuit according to the invention is preferably configured to estimate the time between the two characteristic signal sections using the counter circuit of the invention. The sampling circuit, which may be a sample-and-hold circuit, is especially provided to sample the main data section of the digital signal. Since the counter circuit according to the invention determines the states of the clock signals at the moment of the first characteristic signal section of the digital signal, it is advantageous to select the clock signal, whose rising edge immediately follows after this point in time, as the clock sampling signal for the sampling circuit. Consequently, the counter circuit according to the invention does not just provide a counter with a certain resolution which is normally associated with a much higher clock frequency, but it also provides a clock-sampling signal for the sampling circuit with a lower clock frequency than is normally necessary to achieve a certain synchronization error.

Such a synchronization is necessary to provide satisfactory data transmission between a sender and a receiver. In general, the internal clock of the receiver is synchronized with the internal clock of the sender when transmitting data between a sender and a receiver. Otherwise, the transmitted data would be sampled by a sampling device of the receiver at bad points in time, resulting in transmission errors. It should be noted that the stated problem arises for any sender/receiver combination having independent internal clocks, regardless of the physics of the transmission channel. This means that the problem equally arises for transmitting data by use of sound, light, radio waves and any other medium.

These and other aspects of the invention are apparent from and will be elucidated by way of non-limiting examples described hereinafter.

### BRIEF DESCRIPTION OF THE DRAWINGS

In the drawings,

FIG. 1 shows an embodiment of a clock generator;

FIG. 2 shows clock signals obtained by the clock generator of FIG. 1;

FIGS. 3 to 5 show embodiments of counting circuits according to the invention;

FIG. 6 shows clock signals associated with the counting circuit of FIG. 5;

FIG. 7 shows tables illustrating the functionality of the counting circuit of FIG. 5;

FIG. 8 shows a further embodiment of a counting circuit according to the invention;

FIG. 9 is a sampling circuit which may operate in conjunction with the counting circuit of FIG. 8;

FIG. 10 shows tables illustrating the functionality of the counting circuit of FIG. 8; and

FIGS. 11 to 13 show further embodiments of clock generators.

### DESCRIPTION OF EMBODIMENTS

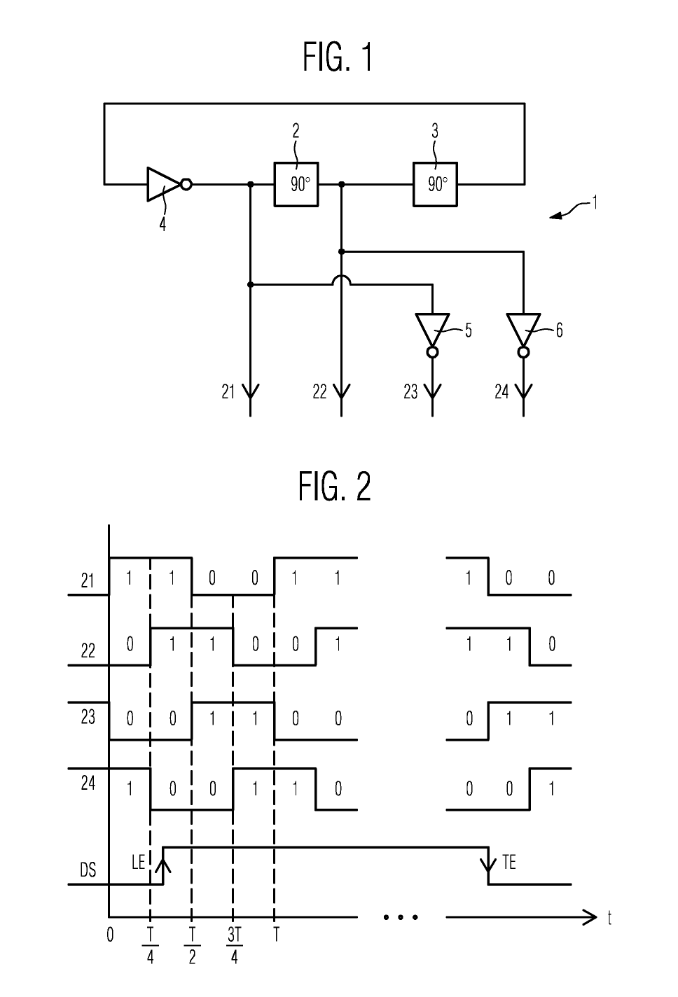

A first embodiment of a clock generator in the form of a ring oscillator 1 is shown in FIG. 1. The ring oscillator 1 generates a first clock signal 21, a second clock signal 22, a third clock signal 23, and a fourth clock signal 24. The four clock signals 21-24 depicted in FIG. 2 are pulsed signals and have the same cycle duration T and the same fundamental frequency, respectively. The ring oscillator 1 comprises a first delay element 2, a second delay element 3, a first inverter 4, a second inverter 5, and a third inverter 6. The first clock signal 21 is present at the output of the first inverter 4, which is connected to the input of the first delay element 2. The first delay element 2 delays the first clock signal 21 by a constant time period T/4, corresponding to a phase shift of 90°. The second clock signal 22 is present at the output of the first delay element 2. The second delay element 3, which is connected downstream to the first delay element 2, delays the second clock signal 22 by the constant time period T/4, corresponding to another phase shift of 90°. The output of the second delay element 3 is connected to the input of the first inverter 4, closing the loop of the ring oscillator 1.

The second inverter 5 is connected downstream to the output of the first inverter 4 and generates the third clock signal 23 by inverting the first clock signal 21. The third inverter 6 is connected downstream to the output of the first delay element 2 and generates the fourth clock signal 24 by inverting the second clock signal 22.

Although the ring oscillator 1 obviously requires power to operate, an appropriate power supply providing an appropriate supply voltage is not shown in the Figures for the sake of brevity. However, the ring oscillator 1 begins to oscillate spontaneously above a certain threshold of the supply voltage.

FIG. 2 shows the four clock signals 21, 22, 23, 24. At time t=0, the first clock signal 21 changes its value from zero to a positive voltage value corresponding to the state “1”. The state “1” of the first clock signal 21 lasts up to t=T/2, when the first clock signal 21 changes its state to “0”. Thus, the first clock signal 21 has a rising edge at t=0 and a falling edge at t=T/2. T is the cycle duration of the clock signals 21, 22, 23, 24. The second clock signal 22 is delayed by T/4 as compared with the first clock signal 21. Therefore, the second clock 22 signal has the state “0” at t=0, changes its state to “1” at t=T/4 and falls back to the state “0” at t=3T/4. Thus, the second clock signal 22 has a rising edge at t=T/4 and a falling edge at t=3T/4. The third clock signal 23 is delayed by T/4 as compared with the second clock signal 22. Therefore, the third clock 23 signal changes its state to “1” at t=T/2 and falls back to the state “0” at t=T. Thus, the second clock signal 23 has a rising edge at t=T/2 and a falling edge at t=T. The fourth clock signal 24 is delayed by T/4 as compared with the third clock signal 23. Therefore, the fourth clock 24 signal has the state “1” at t=0 and changes its state to “0” at t=T/4 and to “1” at t=3T/4. Thus, the second clock signal 22 has a rising edge at t=3T/4 and a falling edge at t=T/4. As a result, the ring oscillator 1 of FIG. 1 provides four clock signals 21-24, each having a cycle duration T (or a frequency 1/T) and each being phase-shifted 90° with respect to each other (or time-shifted by T/4).

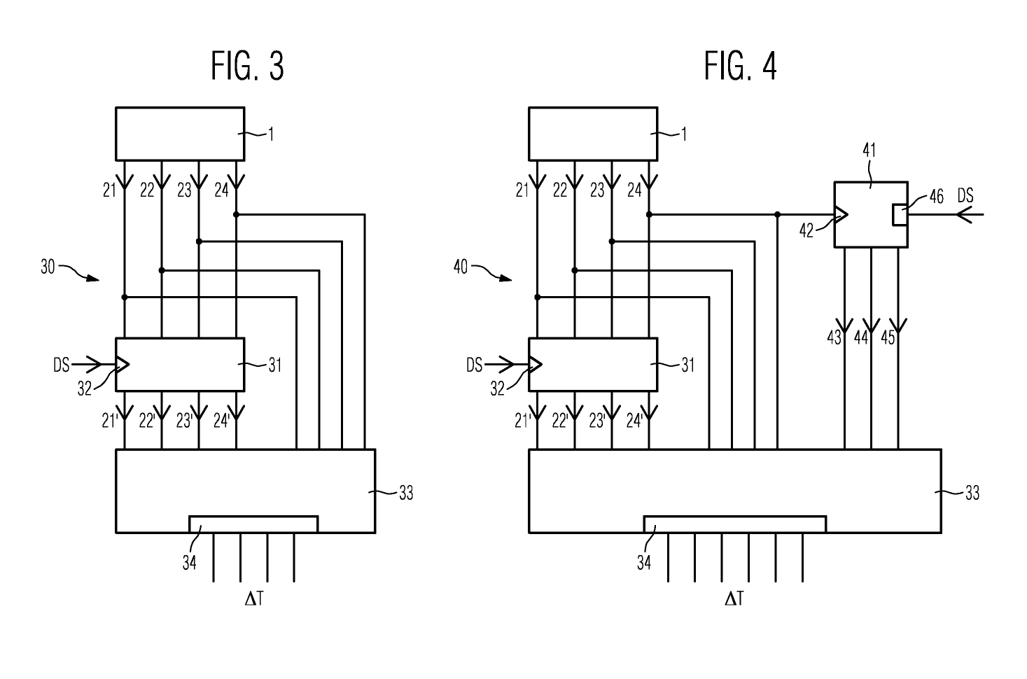

FIG. 3 shows a first counter circuit 30 comprising the ring oscillator 1 of FIG. 1, a latch circuit 31 with a clock input 32, and a logic device 33. The counter circuit 30 may be part of a transponder (for instance, in an RFID tag or a smart card). The purpose of the counter circuit 30 is to count the time starting with the detection of a characteristic section of a digital signal DS. In this embodiment, the characteristic section of the digital signal DS is a rising edge LE of an incoming digital signal DS.

The ring oscillator 1 outputs the four clock signals 21, 22, 23, 24, which are fed to the latch circuit 31. Signals 21′, 22′, 23′, 24′ are present at the output of the latch circuit 31. Additionally, the digital signal DS is fed to the clock input 32 of the latch circuit 31. In this embodiment, the latch circuit 31 is configured to detect a rising edge LE of the digital signal DS. As long as the latch circuit 31 does not detect a rising edge LE of the digital signal DS, the output signals 21′, 22′, 23′, 24′ of the latch circuit 31 are the four clock signals 21, 22, 23, 24. If the latch circuit 32 detects a rising edge LE of the digital circuit DS, the present output signals 21′, 22′, 23′, 24′ of the latch circuit 31 are frozen.

The four clock signals 21, 22, 23, 24 and the output signals 21′, 22′, 23′, 24′ of the latch circuit 31 are the input signals of a logic device 33. The logic device 33 is configured to determine the time ΔT which has elapsed since the latch circuit 31 detected the rising edge LE of the digital signal DS. The logic device 33 determines the time ΔT by comparing the states of the four clock signals 21, 22, 23, 24 with the states of the output signals 21′, 22′, 23′, 24′ of the latch circuit 31. An output signal representing the time ΔT is present at the output 34 of the logic circuit 33. Since the states of the four clock signals 21, 22, 23, 24 recur after every cycle duration T, the logic device 33 cannot correctly measure a time ΔT, which is longer than the cycle duration T. Accordingly, when designing a counter circuit 30, care should be taken that the longest time ΔT, which shall be measured, is less than the cycle duration T of the four clock signals 21, 22, 23, 24.

FIG. 4 shows a further embodiment of a counter circuit 40, which is configured to determine the time ΔT which may be larger than the cycle duration T of the four clock signals 21, 22, 23, 24. Parts of the counter circuit 40 of FIG. 4 which are substantially identical to parts of the counter circuit 30 of FIG. 3 have the same reference signs.

The counter circuit 40 of FIG. 4 differs from the counter circuit 30 of FIG. 3 by an additional counter device 41. The counter device 41, which may be a part of a transponder (for instance, in an RFID tag or a smart card), has a clock input 42 to which the fourth clock signal 24 is fed. Every time when the counter device 41 detects a rising edge of the fourth clock signal 24, it increments its current count CNT by 1. The count CNT is represented by the output signals 43, 44, 45 of the counter device 41. In order to enable the counter device 41, the digital signal DS is fed to an enable input 46 of the counter device 41. As soon as the counter device 41 detects a rising edge LE of the digital signal DS in this embodiment, the counter device 41 is enabled and starts to count. In addition to the four clock signals 21, 22, 23, 24 and the output signals 21′, 22′, 23′, 24′ of the latch circuit 31, the output signals 43, 44, 45 of the counter device 41 are fed to the logic device 33.

The logic device 34 is configured to determine the time ΔT, which has elapsed since the latch circuit 31 detected the rising edge LE of the digital signal DS. The logic device 34 determines the time ΔT by comparing the states of the four clock signals 21, 22, 23, 24 with the states of the output signals 21′, 22′, 23′, 24′ of the latch circuit 32 and by considering the states of the output signals 43, 44, 45 of the counter device 41. An output signal representing the time difference ΔT is present at the output 33 of the logic circuit 34.

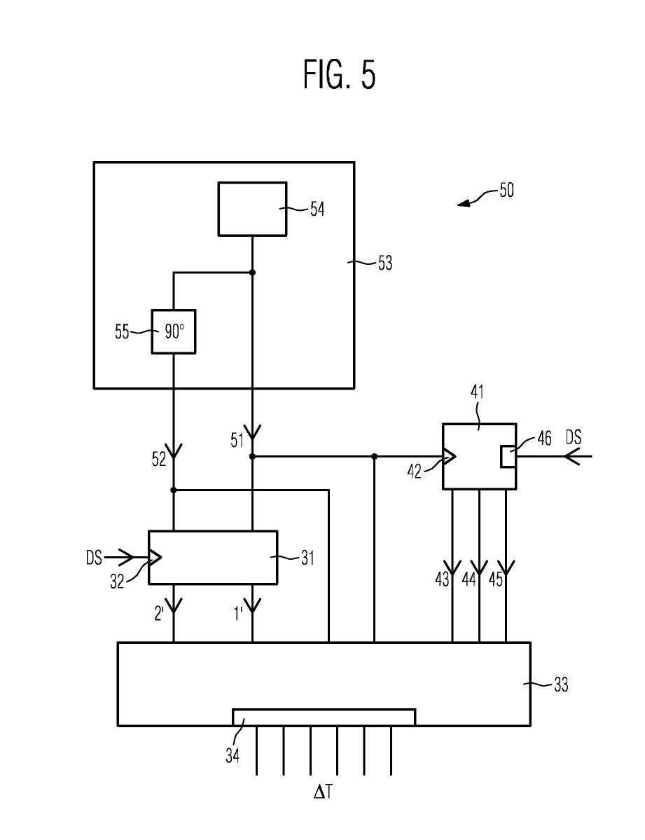

FIG. 5 shows another embodiment of a counter circuit 50, which is configured to determine a time ΔT which may be larger than the cycle duration T. Parts of the counter circuit 50 of FIG. 5 which are substantially identical to parts of the counter circuit 40 of FIG. 4 have the same reference signs.

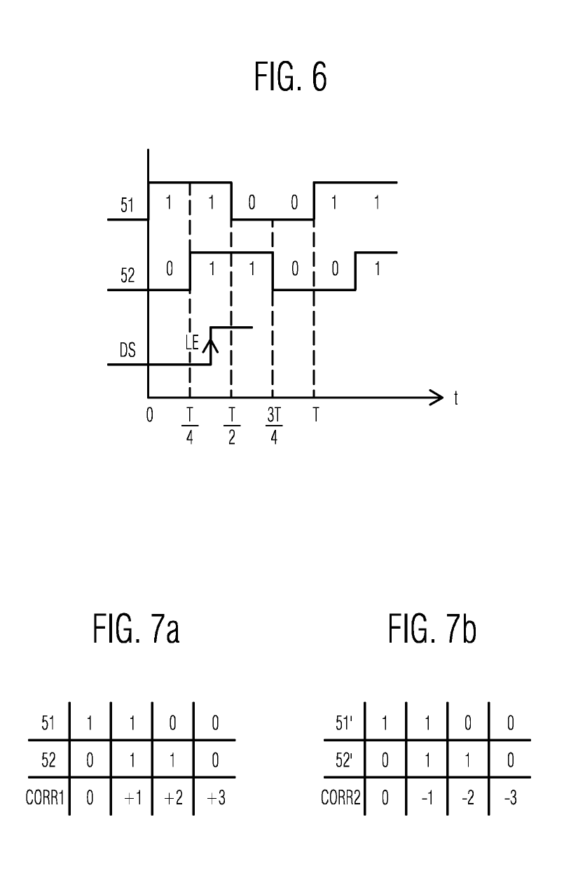

The main difference between the counter circuit 50 of FIG. 5 and the counter circuit 40 of FIG. 4 is the clock generator 53. In this embodiment, the clock generator 53 of the counter circuit 50 generates a first clock signal 51 and a second clock signal 52, which have the same cycle duration T and are shown in FIG. 6. The second clock signal 51 lags the first clock signal 51 by T/4. The clock generator 53 comprises an oscillator 54, which may be a quartz oscillator (however, any other oscillator is applicable as well), and a delay element 55 connected downstream of the oscillator 54. The oscillator 54 generates the first clock signal 51, and the delay element 55 generates the second clock signal 52 by delaying the first clock signal 51 by T/4, corresponding to a phase shift of 90°.

The latch circuit 31 freezes the states of the two clock signals 51, 52 at its output when it detects a rising edge LE of the digital signal DS. Then, a signal representing the time ΔT which has elapsed since the detection of the rising edge LE of the digital signal DS is present at the output 34 of the logic device 33. The time ΔT is calculated in accordance with the following equation:

ΔT=4*CNT+CORR1+CORR2

wherein CNT is the current count of the counter device 41, CORR1 is determined in accordance with FIG. 7a and CORR2 is determined in accordance with FIG. 7b. CORR1 depends on the present states of the first and second clock signals 51, 52 and CORR2 depends on the states of the first and second clock signals 51′, 52′ at the point in time when the latch circuit 31 detects the rising edge LE of the digital signal DS. It should be noted here that the teachings of FIGS. 6, 7a, and 7b are also applicable to the counter circuit 30 of FIG. 3 and to the counter circuit 40 of FIG. 4 in a similar way.

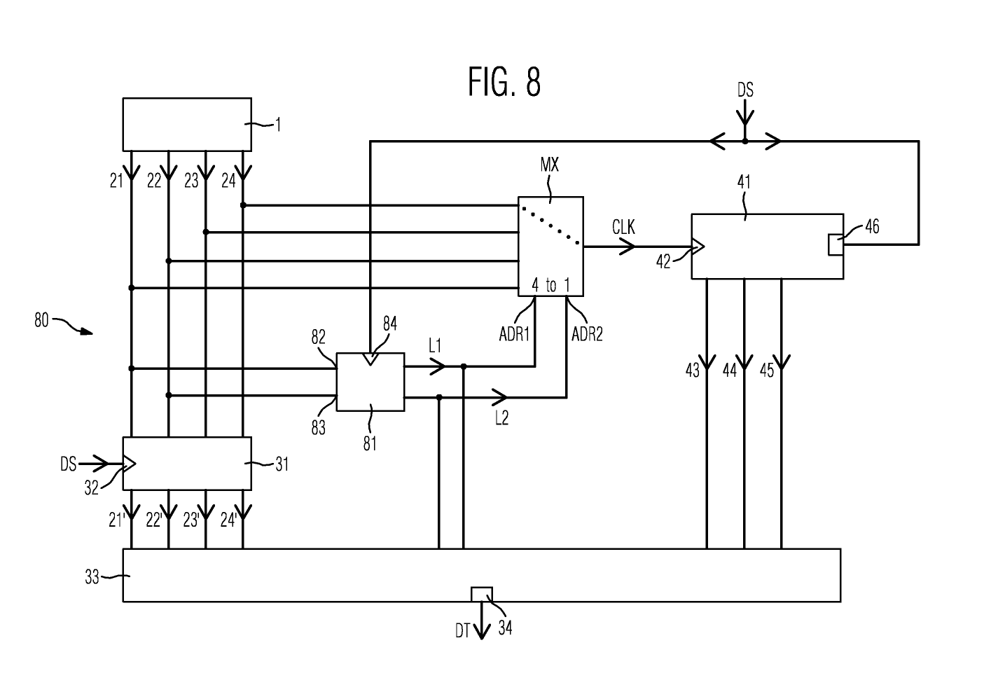

FIG. 8 shows a further embodiment of a counter circuit 80 which is configured to determine the time ΔT, which may be larger than the cycle duration T of the four clock signals 21, 22, 23, 24. Parts of the counter circuit 80 of FIG. 8 which are substantially identical to parts of the counter circuit 40 of FIG. 4 have the same reference signs.

In addition to the counter circuit 40 shown in FIG. 4, the counter circuit 80 shown in FIG. 8 comprises a 4-to-1 multiplexer MX, whose input signals are the four clock signals 21, 22, 23, 24, and a further latch circuit 81. The further latch circuit 81 will hereinafter be denoted as “second latch circuit 81” and the latch circuit 31 will be denoted as “first latch circuit 31”. The multiplexer MX has a first address input ADR1 and a second address input ADR2, each of which can have the state “0” or “1”. Depending on the states present at the two address inputs ADR1, ADR2, one of the four clock signals 21, 22, 23, 24 is present at the output of the multiplexer MX. The output signal of the multiplexer MX is a clock signal CLK for the counter device 41.

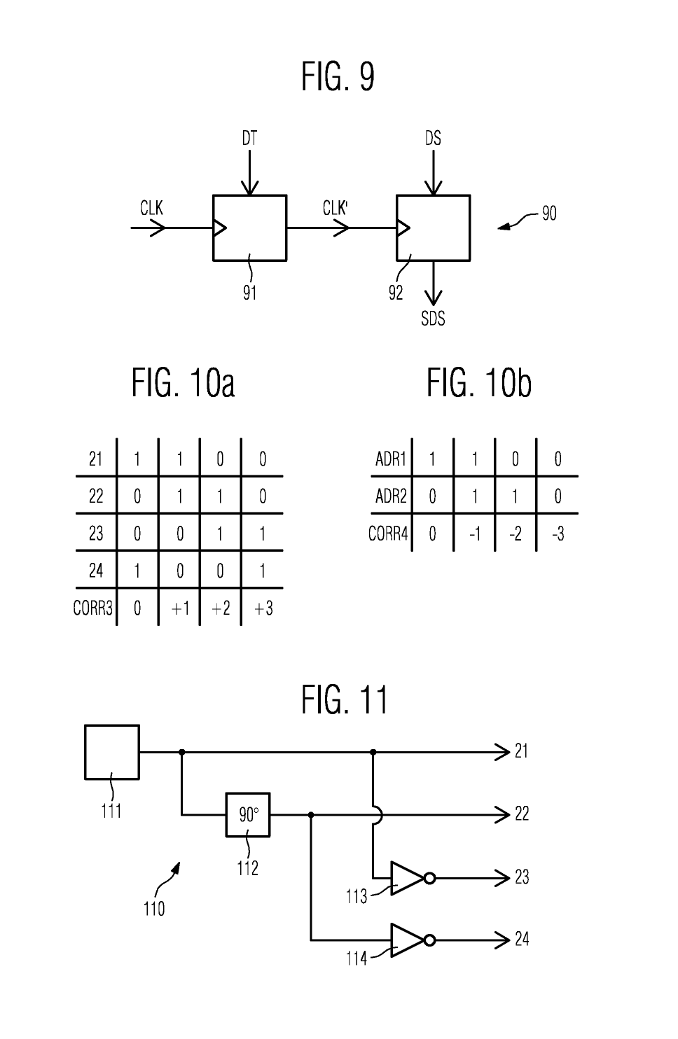

The general purpose of the counter circuit 80 in this embodiment is to measure time, particularly the time ΔT′ between two characteristic signal sections of the digital signal DS, and to generate a clock-sampling signal for a sampling circuit 90 depicted in FIG. 9. The digital signal DS may have a prefix signal section and a main data signal section, which is sampled by the sampling circuit 90 in this embodiment. An example of such a digital signal DS is a communication between a sender and a receiver, wherein information about the data rate that is to be chosen is transmitted in a prefix signal section, and wherein payload data is transmitted in a main data signal section. Accordingly, a sender in a prefix signal section may transmit a pulse to the receiver, whose duration corresponds to a certain data rate. For instance, the longer the pulse duration, the lower the data rate. Subsequently, payload data is transmitted in the main section in accordance with the chosen data rate. An example of such a sender is a reader station and an example of the receiver is a transponder, in particular an RFID transponder or a smart card. Here, the reader transmits an initial pulse to the transponders, which in succession prepare themselves for a certain data rate. Subsequently, data can be exchanged between the reader station and the transponders in accordance with the chosen data rate.

In this embodiment, the two characteristic signal sections of the digital signal DS are a rising edge LE and a falling edge TE of the prefix signal section of the digital signal DS as shown in FIG. 2. Thus, the counter circuit 80 measures the time between the rising edge LE and the falling edge TE of the prefix section of the digital signal DS. The clock-sampling signal for the sampling circuit 90 is the output signal CLK of the multiplexer MX.

The second latch circuit 81 comprises a first input 82, which is fed by the first clock signal 21, and a second input 83, which is fed by the second clock signal 22. The second latch circuit 81 outputs a first output signal L1, which is fed to the first address ADR1 of the multiplexer MX and to the logic device 33, and a second output signal L2, which is fed to the second address ADR2 of the multiplexer MX and to the logic device 33. The second latch 81 comprises a clock input 84 to which the digital signal DS is fed. As long as the second latch 81 does not detect a rising edge LE of the digital signal DS, the output signals L1, L2 of the second latch circuit 81 are the first and second clock signals 21, 22. If the second latch circuit 81 detects a rising edge LE of the digital circuit DS, the present output signals L1, L2 of the second latch circuit 81 are frozen.

The multiplexer MX is configured in such a way that the first clock signal 21 is the clock signal CLK if the first address input ADR1 has the state “0” and the second address input ADR2 has the state “0”. If the first address input ADR1 has the state “1” and the second address input ADR2 has the state “0”, the clock signal CLK is the second clock signal 22. If the first address input ADR1 has the state “1” and the second address input ADR2 has the state “1”, the clock signal CLK is the third clock signal 22. Finally, if the first address input ADR1 has the state “0” and the second address input ADR2 has the state “1”, the clock signal CLK is the fourth clock signal 24.

In contrast to the counter circuit 40 of FIG. 4, the first latch 31 of the counter circuit 80 is configured to freeze its output signals 21′, 22′, 23′, 24′ when the first latch 31 detects the falling edge TE of the prefix signal section of the digital signal DS. Additionally, the counter device 41 of the counter circuit 80 is configured to start counting when it detects the rising edge LE of the prefix signal section of the digital signal DS, and to stop counting when it detects the falling edge TE of the prefix signal section of the digital signal DS.

Consequently, as soon as the second latch circuit 81 and the counter device 41 detect the rising edge LE, the output signals L1, L2 of the second latch circuit 81, and thus the signals for the two addresses ADR1, ADR2 of the multiplexer MX are fixed, and the counter device 41 starts to count. Additionally, the clock signal CLK for the counter device 41 and for the sampling device 60 is selected. As long as the first latch circuit 31 and the counting device 41 do not detect the falling edge TE of the prefix signal section of the digital signal, the output signals 21,′, 22′, 23′, 24′ of the first latch circuit 31 are the four clock signals 21, 22, 23, 24, and the counter device 41 continues to count. As soon as the first latch circuit 31 and the counter device 41 detect the falling edge TE, the output signals 21,′, 22′, 23′, 24′ of the first latch circuit 31 are frozen, the counter device 41 stops to count, and the time ΔT′ remains constant.

In this embodiment, and for the digital signal DS shown in FIG. 2, the states of the two addresses ADR1, ADR2 of the multiplexer MX are “1 1” at the time of the rising edge LE of the digital signal DS, and the clock signal CLK for the counter device 41 thus is the third clock signal 23.

The logic device 33 is configured to determine the time ΔT′ which has elapsed since the rising edge LE of the digital signal DS was detected. The logic device 33 determines the time ΔT′ in accordance with the following equation:

ΔT′=4*CNT+CORR3+CORR4

wherein CNT is the actual count of the counter device 41, CORR3 is determined in accordance with FIG. 10a and CORR4 is determined in accordance with FIG. 10b. As long as no falling edge TE is detected, CORR3 depends on the four clock signals 21, 22, 23, 24 and CORR4 depends on the states of the first and second clock signals L1, L2 at the time when the second latch circuit 81 detects the rising edge LE of the digital signal DS. In the example shown in FIG. 2, CORR4 equals “−1”. When the first latch circuit 31 detects the falling edge TE of the digital signal, the output signals 21′, 22′, 23′, 24′ of the first latch 31 are frozen and are the four clock signals 21, 22, 23, 24 at the moment in time of the falling edge TE. Moreover, the counter device 41 detects the falling edge TE and stops counting. In this embodiment, CORR3 equals “+1” after the falling edge TE occurred. A signal DT representing the time ΔT′ is present at the output 34 of the logic device 33.

In the present embodiment, the main data signal section of the digital signal DS is sampled by the sampling circuit 90 shown in FIG. 9. The sampling circuit 90 comprises a frequency divider 91 and a sample-and-hold device 92 connected downstream to the frequency divider 91. The frequency divider 91 is configured to generate a clock-sampling signal CLK′ for the sample-and-hold device 92, which samples the main data section signal of the digital signal DS so as to generate a sampled digital signal SDS.

In addition to the clock signal CLK, which is also fed to the counter device 41, the output signal DT of the logic device 33 is fed to the frequency divider 91. The signal DT represents a constant time ΔT′ after the falling edge TE of the digital signal DS occurred. Since the sampling device 90 is used to sample the main data section of the digital signal DS, the signal DT represents the time difference between the rising edge LE and the falling edge TE of the prefix section of the digital signal DS and is constant. As stated before, a sender can transmit a pulse, whose duration is representative of a certain data rate. In this particular example, the duration of the pulse can be directly used as a divisor for the frequency divider 91, which is configured in a well-known manner to divide the clock signal CLK into the clock-sampling signal CLK′ being appropriate for the sample-and-hold device 92. However, in principle, also other methods of defining a data rate are feasible. In this case, the signal DT is computed in another appropriate way.

In an alternative embodiment, the output signal CLK of the multiplexer MX is fed to the calculation device 33, instead of the output signals L1, L2 of the second latch 81 to calculate the time ΔT′.

The counter circuits 30, 40, 80 comprise a clock generator which generates four clock signals 21, 22, 23, 24. However, the electric circuit according to the invention is not limited to four clock signals. Furthermore, the counter circuits 30, 40, 80 comprise the ring oscillator 1 as a clock generator, whereas other types of clock generators are also feasible. FIG. 11 shows a second embodiment of a clock generator 110 producing the clock signals 21, 22, 23, 24. The clock generator 110 can be used for the counter circuits 30, 40, 80.

The clock generator 110 of FIG. 10 comprises an oscillator 111, which may be a quartz oscillator (however, other oscillators are applicable as well), one delay element 112, a first inverter 113, and a second inverter 114. The oscillator 111 outputs a base clock signal, which is the first clock signal 21 in this embodiment. The delay element 112 is connected downstream to the oscillator 111 and delays the first clock signal 21 by a time period of T/4 (90°), generating the second clock signal 22. The first inverter 113 is also connected downstream to the oscillator 111 and inverts the first clock signal 21, generating the third clock signal 23. The second inverter 114 is connected downstream to the delay element 112 and inverts the second clock signal 22, generating the fourth clock signal 24.

Although the clock generator 110 obviously requires power to operate, an appropriate power supply providing an appropriate supply voltage is not shown in the Figures for the sake of brevity.

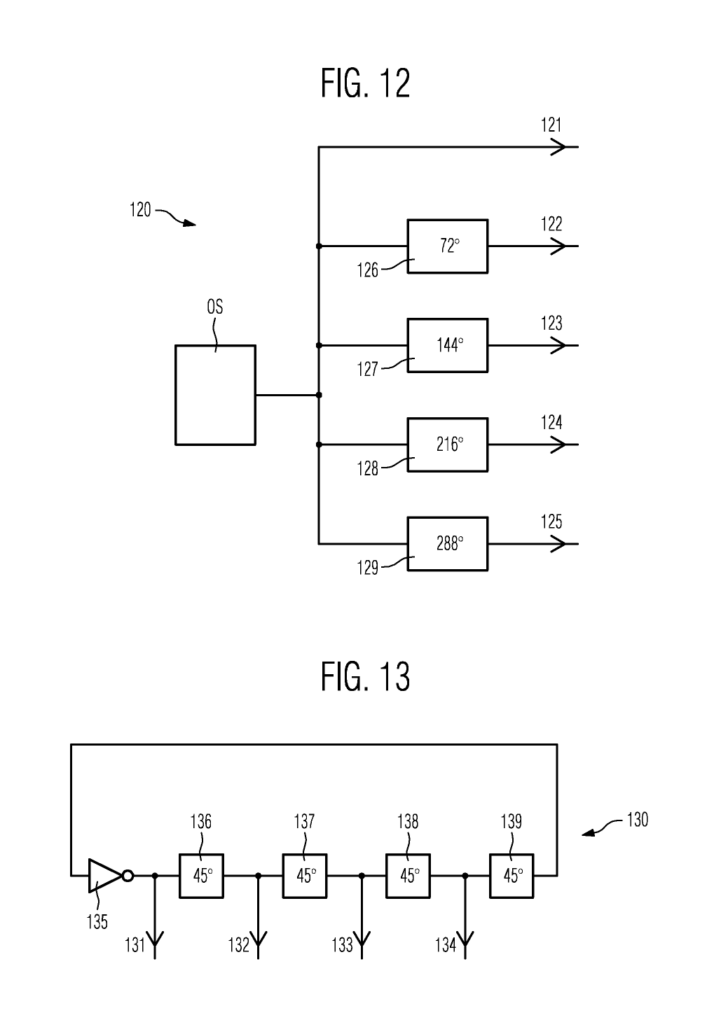

FIG. 12 shows an example of a clock generator 120 that does not provide four, but five clock signals 121, 122, 123, 124, 125. Thus, if used for the counter circuit 80, the multiplexer MX must be replaced by a 5-to-1 multiplexer and the calculation of the time ΔT′ must be modified accordingly. Each of the five clock signals 121, 122, 123, 124, 125 has the same frequency and each of them is phase-shifted 72° with respect to the preceding and succeeding clock signals.

The clock generator 120 comprises an oscillator OS, which may be a quartz oscillator again (however, any other oscillator is applicable as well), a first delay element 126, a second delay element 127, a third delay element 128, and a fourth delay element 129. The oscillator OS outputs a base clock signal which is the first clock signal 121 generated by the clock generator 120.

The four delay elements 126, 127, 128, 129 are each connected downstream to the oscillator OS. The first delay element 126 delays the first clock signal 121 by a time period of T/5 (equivalent to a phase shift of 72°), generating the second clock signal 122. The second delay element 127 delays the first clock signal 121 by a time period of 2T/5 (144°), generating the third clock signal 123. The third delay element 128 delays the first clock signal 121 by a time period of 3T/5 (216°), generating the fourth clock signal 124. The fourth delay element 129 delays the first clock signal 121 by a time period of 4T/5 (288°), generating the fifth clock signal 125.

Although the clock generator 120 obviously requires power to operate, an appropriate power supply providing an appropriate supply voltage is not shown in the Figures for the sake of brevity.

The ring oscillator 1 and the clock generators 110, 120 each generate a plurality of clock signals 21-24, 121-125, each having the same cycle duration T and the same phase shift with respect to the preceding and succeeding clock signals.

FIG. 13 shows an embodiment of a clock generator in the form of a ring oscillator 130 which can also be used for the electric circuits 30, 40, 80. However, the ring oscillator 130 generates four clock signals 131, 132, 133, 134, each having the same cycle duration, but not each clock signal has the same phase shift with respect to its preceding and succeeding clock signals.

In this embodiment, the ring oscillator 130 comprises an inverter 135, a first delay element 136, a second delay element 137, a third delay element 138, and a fourth delay element 139. The output of the inverter 135 is connected to the input of the first delay element 136, the output of the first delay element 136 is connected to the input of the second delay element 137, the output of the second delay element 137 is connected to the input of the third delay element 138, the output of the third delay element 138 is connected to the input of the fourth delay element 139, and the output of the fourth delay element 139 is connected to the input of the inverter 135, closing the ring oscillator 13. Each delay element 136, 137, 138, 139 delays an input signal by a constant time period which corresponds to a phase shift of 45° of the four clock signals 131, 132, 134, 135. Accordingly, there is a phase shift of 45° between the first and the second clock signal 131 and 132, between the second and the third clock signal 132 and 133, between the third and the fourth clock signal 133 and 134, and a phase shift of 225° between the fourth and the (succeeding) first clock signal 134 and 131. One can easily see that the rising and falling edges of the clock signals 131-134 are not evenly distributed over time. However, the invention is also applicable to such embodiments of a clock generator.

Although the ring oscillator 130 requires power to operate, an appropriate power supply providing an appropriate supply voltage is not shown in the Figures for the sake of brevity. However, the ring oscillator 60 begins to oscillate spontaneously above a certain threshold voltage.

It should be noted that all clock signals in the afore-mentioned examples have a duty cycle of 50%, which means that the time periods during which a clock signal is “0” or “1” are equal. However, this measure is not mandatory for the invention. One skilled in the art will easily perceive that the invention also works well with clock signals having a different duty cycle.

It should further be noted that the invention is applicable to all problems ranging from simple clocks to more sophisticated problems where time has to be measured. As stated, one advantage of the electric circuit according to the invention is that a comparably high accuracy can be achieved by using a clock signal for the sampling device having a relatively low frequency. Accordingly, the power consumption is relatively low due to the low frequency, which is particularly advantageous when receiving devices must cope with limited power resources. Examples are smart cards and RFID devices. Particularly when using passive devices (without onboard battery), the radio range of a transponder is a function of the power consumption, i.e. the lower the power consumption, the higher the radio range, which is obviously a fundamental feature of a transponder. Accordingly, the invention is particularly advantageous for passive transponders.

Although the counter devices 41 shown in FIGS. 4, 5 and 8 have only 3 bits, it is easy to understand that the invention relates to counter devices with a different number of bits as well.

It is also easy to understand that the invention does not only relate to the presented combination of rising and falling edges LE and TE of the digital signal DS, but rather to any combination of signal characteristics. One example is to define the first moment in time by detecting a maximum of an input signal and to define the second moment in time by detecting a subsequent rising edge. Thus, the invention is of course not limited to digital input signals, but is also applicable to analog signals.

Although freezing the states of the clock signals was shown only by means of latches, one skilled in the art can easily conceive alternative devices without departing from the scope of the invention. Examples for freezing states of clock signals are all types of memories and registers. Furthermore, one will easily understand that the presented latch mechanism is not the only feasible one. Latch mechanisms which work on a rising or a falling edge, on a pulse, or on a minimum or a maximum of an input signal are also feasible. In addition, switches may be used, which disconnect the clock inputs of the latches. In this case, a special logic device controls the switches in such a way that the electric counter circuit provides a proper time-measuring function. The teachings presented herein are also applicable to such a case without departing from the scope of the invention.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. Use of the verb “comprise” and its conjugations does not exclude the presence of elements or steps other than those stated in any claim or the specification as a whole. The singular reference of an element does not exclude the plural reference of such elements, and vice-versa. In a device claim enumerating several means, several of these means may be embodied by one and the same item of hardware. The mere fact that certain measures are recited in mutually different dependent claims does not indicate that a combination of these measures cannot be used to advantage.

1. An electric counter circuit comprising:
a clock generator for generating a plurality of clock signals, each having the same cycle duration and being phase-shifted with respect to each other,
a sampling device for sampling said clock signals at a first moment in time when a first characteristic signal section of a digital signal appears; and
a calculation device for calculating the time between said first moment and a second moment in time which is later than said first moment, based on said clock signals at said first moment in time and based on said clock signals at said second moment in time.

2. The circuit of claim 1, comprising a counter device which is clocked by one of said clock signals and generates a count based on said one of said clock signals; said calculation device being configured to determine said time between said two moments based on said count in addition to said clock signals at said first moment and based on said clock signals at said second moment.

3. The circuit of claim 1, wherein said clock generator comprises an oscillator for generating a base clock signal and a signal-processing device for generating said plurality of clock signals from said base clock signal.

4. The circuit of claim 1, wherein said clock generator is a ring oscillator.

5. The circuit of claim 1, wherein said first characteristic signal section is one of a rising edge, a falling edge, a maximum, or a minimum of said digital signal.

6. The circuit of claim 1, comprising a device for sampling said clock signals at said second moment in time which is associated with a second characteristic signal section of said digital signal.

7. The circuit of claim 6, wherein said second characteristic signal section is one of a rising edge, a falling edge, a maximum, or a minimum of said digital signal.

8. An electric circuit comprising:
said electric counter circuit according to claim 1; and
a sampling circuit for sampling said signal.

9. The electric circuit of claim 8, wherein said digital signal has a prefix signal section and a main data section; said prefix signal section comprising said first characteristic signal section being associated with said first moment in time, and a second characteristic signal section lagging said first characteristic signal section and being associated with said second moment in time, and said sampling circuit sampling said main data section.

10. The electric circuit of claim 9, wherein said electric counter circuit comprises a counter device which is clocked by one of said clock signals and generates a count based on said one of said clock signals; said calculation device of said electric counter circuit (80) being configured to determine said time between said two moments based on said count in addition to said clock signals at said first moment and at said second moment, and said one of said clock signals being used as a clock signal for said sampling circuit.
